(19) United States
(12) Patent Application Publication
(10) Pub. No.: US 2019/0294965 A1
(43) Pub. Date: Sep. 26, 2019

(54) SYSTEMS AND METHODS USING ARTIFICIAL INTELLIGENCE TO ANALYZE NATURAL LANGUAGE SOURCES BASED ON PERSONALLY-DEVELOPED INTELLIGENT AGENT MODELS

(71) Applicant: Vettd, Inc., Bellevue, WA (US)

(72) Inventors: Andrew Buhrmann, Redmond, WA (US); Michael Buhrmann, North Bend, WA (US); Ali Shokoufandeh, New Hope, PA (US); Jesse Smith, Bellevue, WA (US)

(21) Appl. No.: 16/361,917

(22) Filed: Mar. 22, 2019

Related U.S. Application Data
(60) Provisional application No. 62/647,518, filed on Mar. 23, 2018.

(51) Int. Cl. G06N 3/08; G06N 20/00

(52) U.S. Cl. CPC G06N 3/08; G06N 20/00

(57) ABSTRACT

A system and method for creating an intelligent agent model for providing an expert opinion on source data includes obtaining at least one first data source for training an intelligent agent model, receiving training input on the at least one first data source from an individual, extracting a set of relevant attributes of the at least one first data source based on the received training input, weighting the set of relevant attributes based on at least one of the received training input or prior received training input, forming at least one neural network that comprises the intelligent agent model based on the set of relevant attributes and the weighting, ranking or scoring at least one section of a second data source using the intelligent agent model, and outputting the ranking or scoring.

### PRIORITY CLAIM

This application claims priority from U.S. Provisional Application No. 62/647,518 filed Mar. 23, 2018; which application is hereby incorporated by reference as if fully set forth herein.

### RELATED APPLICATIONS

This application is related to U.S. application Ser. No. 14/952,495 filed Nov. 15, 2015, titled “Systems and Methods to Determine and Utilize Conceptual Relatedness Between Natural language Sources;” and U.S. Provisional Application No. 62/521,792 filed Jun. 19, 2017, titled “Systems and Methods to Determine and Utilize Semantic Relatedness between Multiple Natural Language Sources to Determine Strengths and Weaknesses.” The contents of these applications are hereby incorporated by reference as if fully set forth herein.

### COPYRIGHT NOTICE

This disclosure is protected under United States and/or International Copyright Laws. ©2018, 2019 Vettd, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### FIELD OF THE DISCLOSURE

This disclosure relates generally to the field of artificial intelligence and more specifically to creating analytical models based on the learned expertise of individuals to analyze data sources.

### BACKGROUND

Currently, techniques to analyze data sources, such as documents, speech, etc., generally use a body or corpus of data (e.g., obtained via crowdsourcing) to perform comparisons on the data source to identify key words or concepts. These techniques utilize natural language models, neural networks, and the like to tailor the results of the comparisons to better align with a set of metrics or benchmarks used to identify documents that meet these criteria. However, because the individual sources of the data used for comparison and building the models are not known or individually analyzed, the models can produce inaccurate results. As such, improvements can be made in the field of language and speech analysis.

### SUMMARY OF THE INVENTION

In accordance with a preferred embodiment of the present invention, a system for developing an intelligent agent model of intelligent computational agents, comprises a curation tool for obtaining information from an expert, the curation tool generating training data received by a computational block employing an algorithm to generate encoded expertise based on the training data and an intelligent agent created at least in part by and coupled to receive the encoded expertise.

In accordance with a further embodiment, a method for creating an intelligent agent model for providing an expert opinion on source data, the method comprises the steps of obtaining at least one first data source for training an intelligent agent model, receiving training input on the at least one first data source from an individual, extracting a set of relevant attributes of the at least one first data source based on the received training input, weighting the set of relevant attributes based on at least one of the group of the received training input and prior received training input, forming at least one neural network that comprises the intelligent agent model based on the set of relevant attributes and the weighting, ranking or scoring of at least one section of a second data source using the intelligent agent model, and outputting the ranking or scoring.

### BRIEF DESCRIPTION OF THE DRAWINGS

Preferred and alternative examples of the present invention are described in detail below with reference to the following drawings. In the drawings, identical reference numbers identify similar elements or acts. The sizes and relative positions of elements in the drawings may not be necessarily drawn to scale. For example, the shapes of various elements and angles may not be drawn to scale, and some of these elements may be arbitrarily enlarged or positioned to improve drawing legibility:

FIG. 1 illustrates an example system/workflow for creating and modifying expertise neural networks used in the employment/recruiting space, in accordance with an embodiment of the present disclosure;

FIG. 2 illustrates an example system/process for creating an intelligent agent model in accordance with system illustrated in FIG. 1;

FIG. 3 illustrates an example user interface for inputting text or other data for use by the intelligent agent model of FIG. 2;

FIGS. 4-5 illustrate example user interfaces/dashboards of the Employer Applicant Application of the system of FIG. 2;

FIGS. 6-7 illustrate an example user interface/dashboard of the Recruiter Interface of the system of FIG. 2;

FIGS. 8-9 illustrate an example user interface/dashboard of the Manager Application of the system of FIG. 2;

FIG. 10 illustrates an example process or workflow for enhanced engagement of job applicants performed by the system of FIG. 2;

FIG. 11 illustrates an example process or workflow for talent organization performed by the system of FIG. 2; and,

FIG. 12 illustrates an example process for training and using an intelligent model to score a data source, which may be performed by the system of FIG. 2.

### DETAILED DESCRIPTION

The present disclosure addresses one or more problems identified in the background section by creating intelligent agent models, each based on curated input from an individual. In one aspect, an individual with expertise in a particular field or area may review documents and provide input as to the value of statements in the document. The described systems and techniques may provide targeted questions and selection items to help the individual better and more effectively analyze and provide feedback as to the value of specific statements in certain contexts, such as reviewing a resume, for example. In some examples, the selection options may be binary (e.g., useful or not useful) or may provide a range of values or responses corresponding to usefulness or applicability. The input from the individual can then be used to form an intelligent agent model that in essence encodes that individual's expertise. For example, an intelligent agent model for hiring sales managers may be built from an individual having a lot of experience in sales. In some aspects, the intelligent agent model may include a neural network designed based on inputs received from the individual. The intelligent agent model may analyze documents and provide an expert opinion on those documents, for example via any of a number of interfaces, such as a web tool, through software as a service, etc. This may include providing input for an applicant drafting a better resume, or conversely, a recruiter finding a better match for an open position, more effectively.

By encoding the inputs based on a single individual, the model that is created may be examined and then further adapted to emulate expertise based on the individual to a much higher degree. For example, a certain model may analyze a document and provide a certain result. Through feedback systems, the original individual on whom the model was based may then say whether or not they agree with an opinion or output of the model. The model may then be corrected to align to a higher degree to the opinions of the individual. In addition, the rationale for a given decision based on certain inputs by the model relative to a document or data source may also be provided to enable better usage of the output. For example, a model may rank a statement in a resume as poor because it lacks specific detail pertaining to the question. This output may be much more useful to a user of the system than simply a poor or low ranking of a given statement.

In some aspects, multiple models may be created and used to analyze the same source data or document. This may provide much more useful information to the user of the system to enable more effective and useful feedback to the data source. The feedback may take the form of changes to improve the data source or document based on an expert opinion. In yet some aspects, an intelligent agent model may be created and then provided through a marketplace or trading interface for use by others. This may take the form of an online market place, or a software as a service arrangement where certain expertise may be provided based on need. In this example, an interface may be provided, such as a web based interface, software as a service, etc., to enable multiple individuals to provide feedback on data sources to encode their expertise into a portable intelligent agent model. The intelligent agent model may then be uploaded to a central system (e.g., cloud-based system) for eventual access and use by others (e.g., users of a market place).

In some aspects, a microprocessor executable method and system is provided for analyzing natural language source(s) based on algorithms trained by individual or group curators to identify strengths and weaknesses. Portions of natural languages are identified by the curator, computationally characterized in finite vector spaces, and mathematically processed. Intelligent agent models are trained by either individual or multiple curators to identify specific sought-after characteristics as a calculated metric. The metric is associable to preferences or dislikes of natural language or other data source(s) to graphically present the level of relatedness and identify preferences or dislikes between the metric and the natural language. The metric may be re-determined with algorithms designed to provide multiple views of likes, dislikes, gaps and strengths between sources.

In some aspects, intelligent computational agents generated from an individual or individuals may be utilized to develop machineries for mappings of preferences, dislikes, strengths and weaknesses (or gaps) using natural language source documents. The computational models of intelligent agents are developed based on a curator(s) using their background, experience, opinions, likes or dislikes, and subject matter expertise to identify and prioritize the most important attributes and characteristics for a topic or subject. This list of attributes and characteristics may be converted into a machine learning model that becomes the basis for analyzing the future source documents. The model can be enhanced and refined based on its future use cases and feedback by the curator(s).

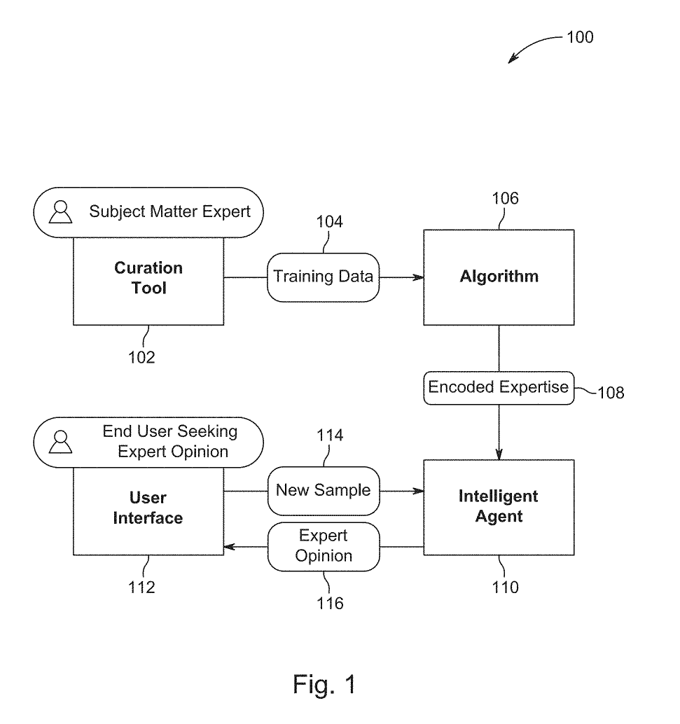

One embodiment of a system/process for developing the intelligent agent model of intelligent computational agents is illustrated in FIG. 1. A curation tool 102 may be used to obtain information from an expert concerning one or more subjects or topics. The curation tool 102 may take the form of an interface for providing questions to a curator on relevance or value of statements in one or more data sources/documents. The curation tool 102 may generate training data 104, which may then be used by a computational block employing one or more algorithms 106 to generate encoded expertise 108 based on the individual's inputs. The encoded expertise 108 may then be used to form the intelligent agent model 110. The intelligent agent model 110 may take the form of one or more neural networks, mapping characteristics or features to certain values or weights, as will be described in greater detail below.

As one example, the architecture of the neural network utilized in the described system may include a deep neural network consisting of three distinct substructures. The first substructure is the embedding layer that is responsible for generating a vector encoding of textual information that will be provided as input to the system. The output of the embedding layer or substructure will be fed to multiple 1-dimensional convolutional layers that are responsible for capturing the language syntactic and semantic dependencies associated with the input document. The convolution layers can also contain several recurrent neural layers in the form of long/short term memory cells that are responsible for capturing temporal dependencies in the text. The output of the convolution layers will in turn be provided as input to a perceptron dense sub-network that will be responsible for the final classification and decision making tasks.

Once the intelligent agent model 110 is created, an end user may interface with the intelligent agent model 110 via one or more user interfaces 112. The user interface 112 may provide new samples 114 to the intelligent agent model 110, and the intelligent agent model 110, after analyzing the new sample 114 via the model 110, may return an expert opinion 116.

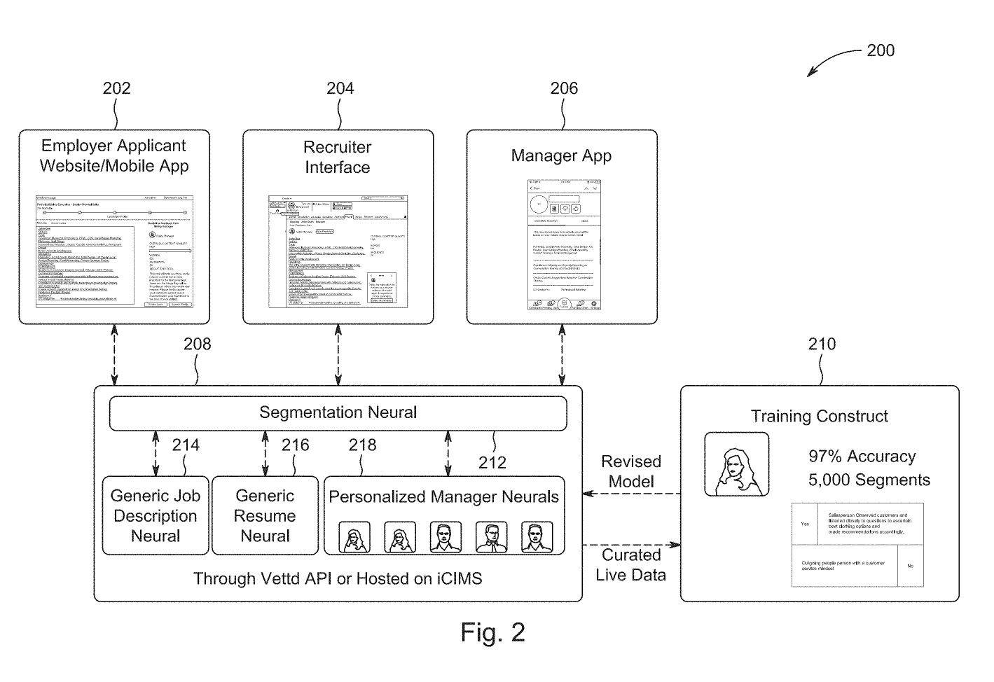

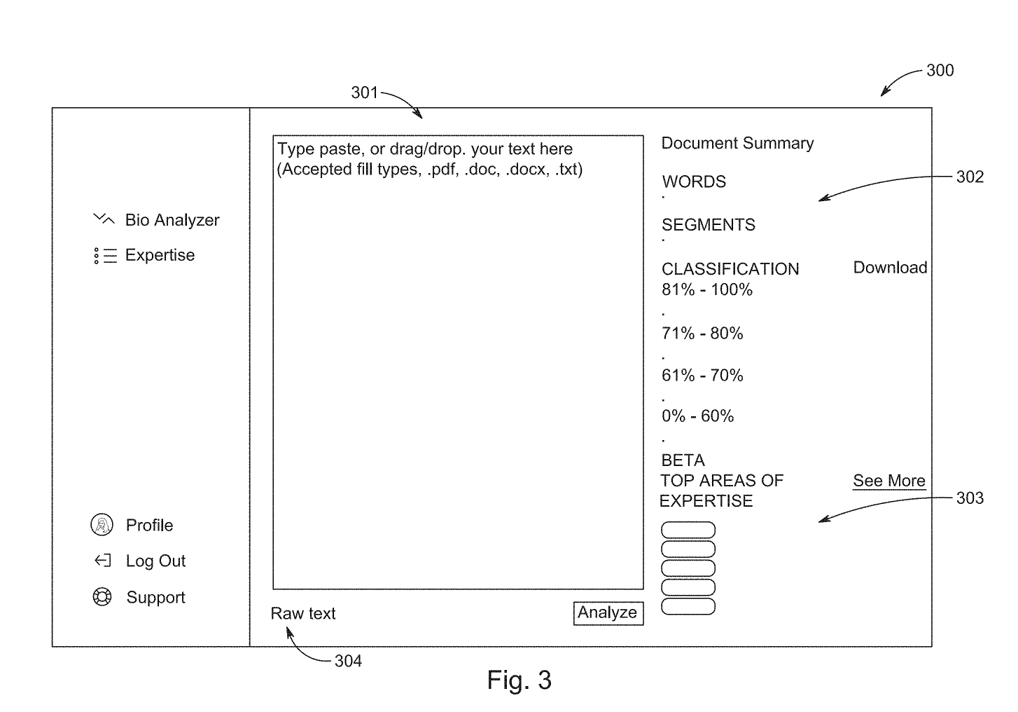

In one use case, a curator may desire to have a characterization model identify the critical attributes for persons in a given position. The microprocessor-based system may provide the curator with choices to develop an initial preference mapping for the intelligent agent model based on the unique opinions and knowledge of the curator. Source documents that are fed into the described system consist of any information and could include resumes, profiles, job descriptions, description of project reports, annual personnel evaluation reports, and other personal information that describe that individual's job functions, responsibilities, experience, and ongoing education, experience, and career growth. FIG. 3 illustrates an example of one such input mechanism 300 for source documentation, for example, that may be provided by system 200, described in more detail in reference to FIG. 2 below. The intelligent agent model may exploit the contextual concepts to computationally map the individual's source documents against the unique and beneficial knowledge encoded from the curator in the intelligent agent model to determine strengths and gaps of the individual against the intelligent agent model and map the curator's position preferences accordingly.

The described systems and methods may include artificial intelligence components that allow the described system/models to continuously learn and train the intelligent agent model so that it can change over time based on feedback and additional input from the curator or other sources. In some iterations, individuals, whose source documents are analyzed by the intelligent agent model, may have the ability to query the described system to understand the curator's logic that drives the determination of strengths and gaps, and provide new information for the intelligent agent model to perform a subsequent iteration. In other iterations, multiple intelligent agent models may be built that work collaboratively to look at the source documents and provide complementary insights or form an interconnected set of pre- and post-processing pipelines.

The elements of a pre- or post-processing pipeline may include a sequence of individual neural network agents which are trained to carry different tasks. The combination of the individual neural network will provide the ability of performing complex tasks. For example, the output of a network responsible for extracting the most semantically salient portion of a document such as a resume can be fed into a network that is capable of quantitatively evaluating a resume for specific skills or capabilities. The pipelines are complex networks to carry out designated tasks where each element in their structure are themselves individual neural networks.

After initial development, the intelligent agent model may be deployed or exported by the curator across platforms with necessary base system configurations.

In some aspects, one or multiple intelligent agent models may be employed as an interactive artificial intelligence (AI) encoded expertise as a service. In this implementation, one or more models may be accessed via a communication network (e.g., the internet), to provide analysis and/or an expert opinion on any of a number of data sources.

The described techniques may provide for one or more of the following benefits and advantages, for example, with particular reference to a resume/recruiting application. It should be appreciated that the described techniques may be used for other applications as well, such as capturing tribal or institutional knowledge in an organization, or any of a number of other fields, and may provide similar advantages.
Engages applicants with real-time feedback improving company brand experience.
Removes the feeling of submitting resumes into a “black box”.
Allows for applicants to properly communicate their work experience in a way that is better aligned with the employer and hiring manager perspective.
Educates recruiters on what to focus on in a candidate's background and how to formally summarize talent.
Helps remove bias from the recruiting process as hiring managers are objectively guiding recruiters to review the most relevant content on each applicant.
Hiring managers can spend more time focusing on their existing team by improving the applicant review process with minimal investment.
Engaging applicants on a deeper, more detailed-oriented level.
Educating recruiters to enable finding better matched talent more effectively and efficiently.
Improving hiring manager efficiencies.
Encoding expertise to a platform that can be used for a wide range of applications.

FIG. 2 illustrates an example system/workflow 200 for creating and modifying expertise neural networks (intelligent agent models) used in the employment/recruiting space, as one example implementation of the present disclosure. System 200 may implement process 100 described above in reference to FIG. 1. System 200 may include neural network sub-system 208, which may communicate with/be accessed by an Employer Applicant Application 202, a Recruiter Interface 204, and a Manager Application 204 via one or more communication networks. Each or multiple of the neural network sub-system 208, the Employer Applicant Application 202, the Recruiter Interface 204, and/or the Manager Application 204 may be provided by one or more physical machines, cloud resources, or a combination thereof.

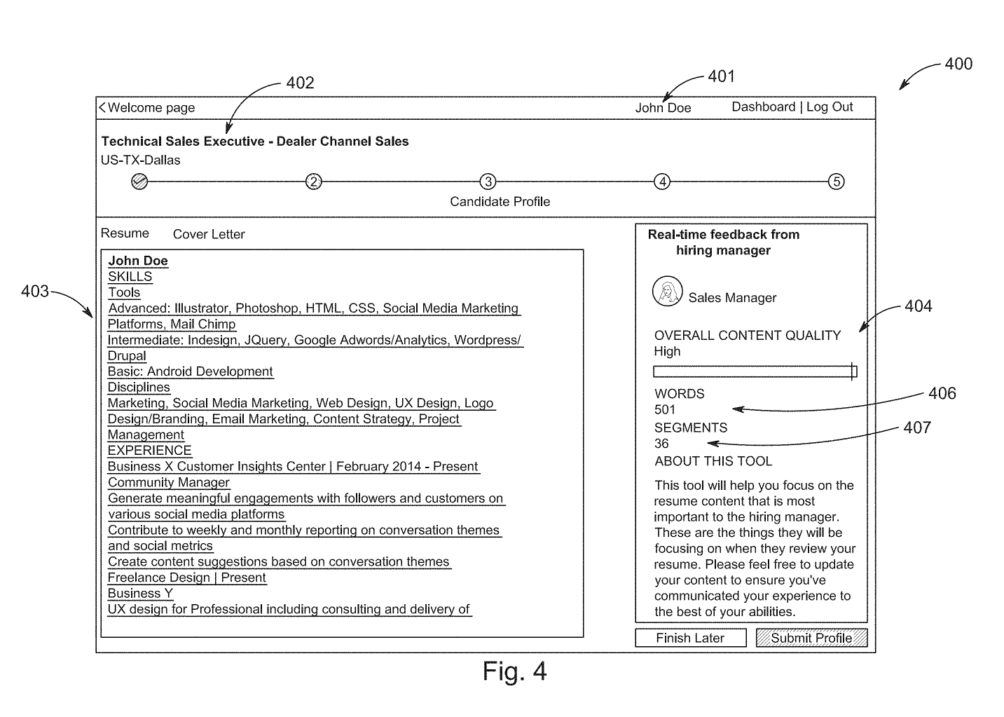

The neural network sub-system 208 may include a segmentation neural network 212 (neural), which may direct requests from any of the Employer Applicant Application 202, the Recruiter Interface 204, and/or the Manager Application 204 to one or more different neurals, including a generic job description neural 214, a generic resume neural 216, or one or more personalized manager neurals 218, depending on the content of the request/origin of the request. The neural network sub-system 208 may interact with different training constructs 210 to develop each personalized manager neural 218. This may include providing an interface for experts to curate live data and receiving inputs that in turn are used to update the manager neurals 218. The functionality of each of the Employer Applicant Application 202, the Recruiter Interface 204, and the Manager Application 204 will be described in greater detail in reference to FIGS. 4-9 below.

In some aspects, system 200 may provide a source input mechanism/interface 300 as illustrated in FIG. 3. Input interface 300 may provide for various tools and selection items for providing comments, rating, values, etc. to words and phrases in source documents. The metadata associated with the document will be communicated with end user through info boxes in 302. These activities will be conducted through a dialog box depicted in 301. These tools and selection items may include tools for highlighting or selecting portions of text (or images, etc.) and associating a ranking to them and will be provided through interface box 301. In some aspects, system 200 may divide a source document into a number of segments prior to requesting feedback from a reviewer/expert. In this way, the feedback received (e.g., comments or ranking) may be directed to specific segments, and associated contexts, of a data source or document that will be communicated to the end-user in dialog box 301. The individual segments may be determined, for example, based on context (e.g., natural language analysis, concept analysis, etc.), formatting of the data source (including meta data of the data source), comparison of the data source to standard or model data sources, or a variety of other factors or attributes of the data source and content thereof. In yet some aspects, interface 300 may provide for a freeform tool that enables a reviewer/expert to provide feedback on selected portions of the data source, for example, by highlighting or selecting text or other content and providing comments, ranking, etc., pertinent to the selected content through a separate dialog box as depicted in 304 or based on existing labels provided by selection bars in 303. In some cases, this freeform tool may be used to then derive segmentation information that enables system 200 to segment data sources based on initial passes by an expert through data sources of similar type, content, etc.

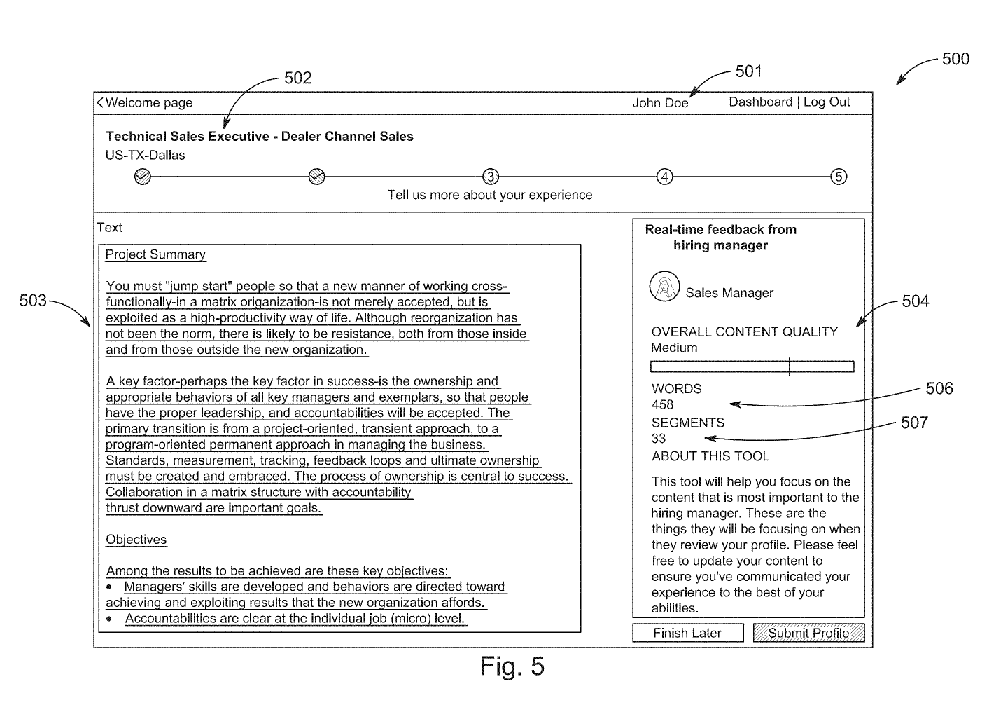

FIGS. 4-5 illustrate example user interfaces/dashboards 400 and 500 of the Employer Applicant Application 202 of system 200 described above in reference to FIG. 2. Interfaces 400 and 500 may provide an overall rating of source documents submitted by an applicant identified by boxes 401 and 501 to a job posting identified by boxes 402 and 502, for example. The distinction between 400 and 500 is in the type of information processed by each instance. In the case of 400 the processed document is a candidate resume. In 500 the processed document is a description of a statement of capabilities and roles for candidates in projects he/she has participated in.

After uploading or copying and pasting a resume or LinkedIn profile through dialog boxes 403 and 503, the applicant can receive live feedback from the hiring manager through their trained Neural via interfaces 400/500 as highlighted in dialog boxes 403 and 503. If desired, the applicant can update and resubmit their resume or edit their contents through the text editor provided in boxes 403 and 503. Interfaces can provide updated analysis in response to the modified text or document. Interface 400/500 can also communicate the overall quality of the content within the resume to ensure that the applicant has described enough about themselves in the right context. This overall quality is depicted in heatmap bar depicted by 404 and 504. Since the hiring manager's Neural is not recommending what to say but rather confirming it was said well via the qualitative visualization depicted in heat bars 404 and 504, the applicant is able to retain their own voice and individuality. This is a key differentiator from known prior art systems. By providing rankings or scoring of existing content, and not suggesting or generating new content, the described system and processes take language analysis to another level. The interface will also provide an account of metadata associated with documents such as the number of words represented in 406 and 405 and high-quality text segments identified by neural system 407 and 507.

In some cases, for example, if an applicant needs to answer specific work history questions or doesn't have a resume and needs to write about their work experience, the hiring manager's Neural can ensure there is enough quality content for the applicant reviewer through identifying deficiencies or providing lower scores for specific aspects of the provided content through the color-coding of highlighted segments in dialog boxes 403 and 503.

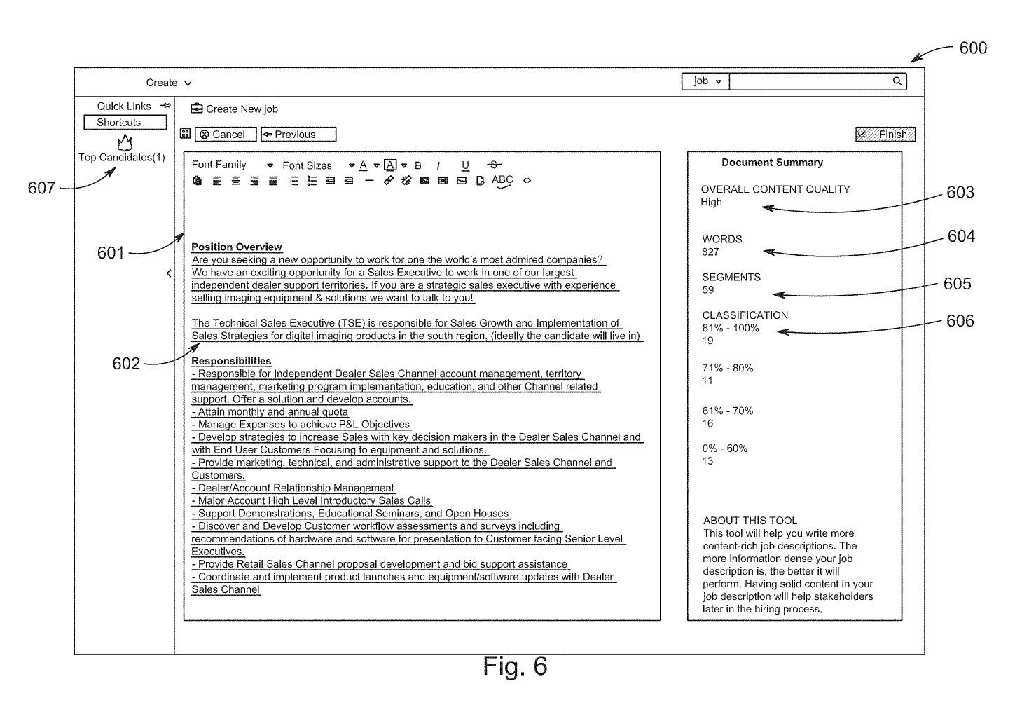

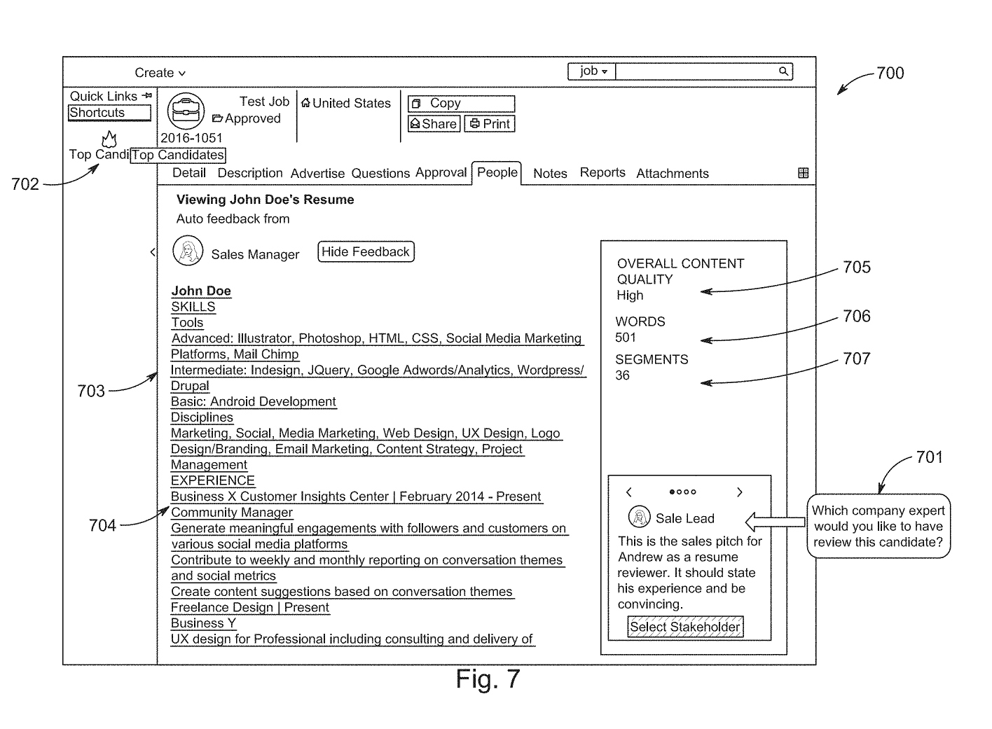

FIGS. 6-7 illustrate example user interfaces/dashboards 600 and 700 of the Recruiter Interface 204 of system 200 described above in reference to FIG. 2. The dashboard 600 is provided to manage and interact with the position description. The Dashboard 700 provides an interactive interface for examining and evaluating a particular candidate by the hiring staff and managers.

Interface 600 may provide tools and selection items for offering writing assistance for job descriptions in job postings through a dialog box 601 with a comprehensive editing functionality. For example, marketing language in a job description may be somewhat valuable, but can take away from informing candidates and reviewers about what really matters, such as details of the job, required skills, etc. By utilizing a specially trained Neural, recruiters can ensure there is enough relevant content describing the work that needs to be done and the knowledge required to do the job to attract better, more qualified talent. The results of these neural polarity evaluations will be communicated to the end-user by a spectrum of highlights illustrated in 602 through the interface 601. The dashboard 600 will provide aggregate evaluation of overall document quality via metadata 603. The interface also provides sample statistics for the document through dialog box interfaces 604 and 605. Both interfaces 600 also provide a detailed distribution on the quality of sentences in a document in quantiles via sub-dashboard 606.

Interface 700 may provide tools and selection items for reviewing resumes with the hiring manager's relevance of candidate as presented in emoji 702. For example, interface 700 may provide different hiring manager Neurals for recruiters to help guide them in the applicant review process. The results of evaluating the content of the document will be visualized through the dialog box 703 as highlighted with different color coding as indicated by 704. This process helps to dramatically reduce unconscious bias by having an objective review process that will guide the recruiter to relevant content regardless of the recruiter's experience. A important benefit to encoding expertise in this manner is that companies can also retain the knowledge and opinion from experts who may have moved on to other opportunities. This may be particularly useful in organizations having a large amount of institutional knowledge, internal processes, etc. Interface 700, and system 200 more generally, may provide better and more efficient ways to capture that knowledge without requiring too much time from employees and others within the organization. The system will also provide an overall qualitative evaluation of expertise for the underlying job description via dialog box 705. The system will also provide metadata and summary statistics about the document through dialog boxes 706 and 707. Interface 700 will also provide a way to help recruiters have objective conversations with hiring managers about improving the quality of job descriptions as related to job candidates via items provided by dialog box 701.

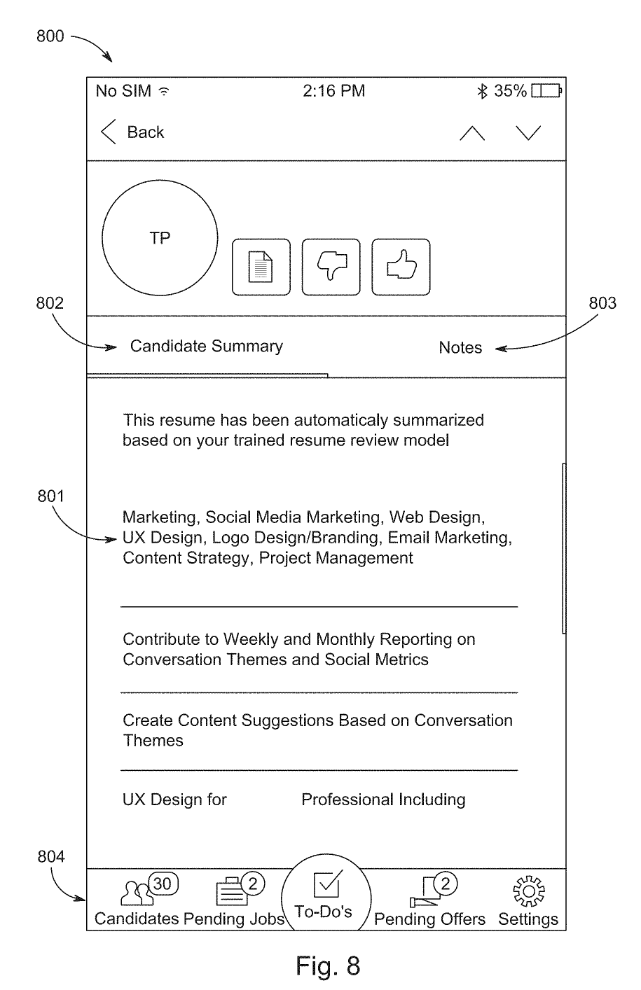

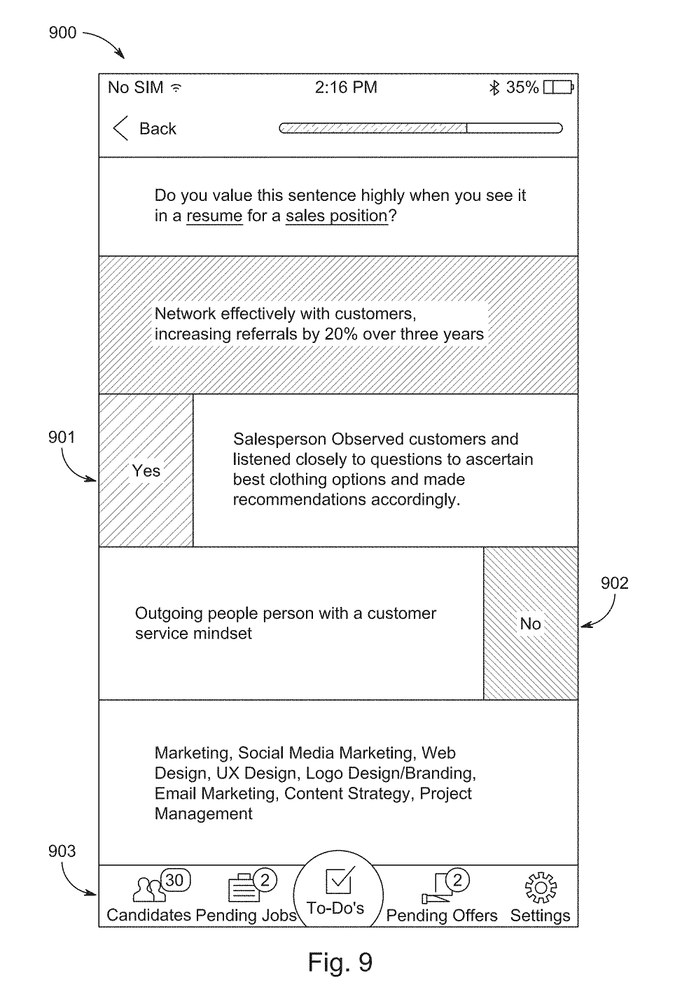

FIGS. 8-9 illustrate example user interfaces/dashboards 800 and 900 of the Manager Application 206 of system 200 described above in reference to FIG. 2.

Interface 800 may provide tools and selection items for summarizing a candidate using one or more neural cells of system 200. For example, when hiring managers need to review applicants, their Neural will automatically summarize the applicant's resume or cover letter from their perspective to ensure they don't have to sift through all the noise. This mode of operation can be selected through the tab provided by 802. The summarized statements will be available to the end-user through a dialog box 801. These statements can help make faster decisions as well as expedite interview preparation time. These summaries can also be used to help guide recruiters on phone screens and preliminary interviews. The system will also provide an interface for note taking by the end-user that can be selected through tab 803. The system will also provide an information panel for the end-user for work load management in 804.

Interface 900 may provide tools and selection items for more efficient training of intelligent agent models/neurals. Given the assistance of multiple AI services, live data from real applicants may be curated into a construct where the hiring manager simply has to identify the statements that they find valuable and those which they don't. This interactive process will be supported through dialog box in 901. In some cases, within as little as an hour or two, hiring managers can have highly accurate neural networks emulating their expertise and opinions. For example, according to testing, after flagging only a few thousand statements, the hiring manager's Neural can hit an optimization point with 95-99% accuracy and will be able to correct or adapt the model over time. The quality of statements and their corresponding qualitative ranking will be highlighted and presented to the end user by proper color coding as indicated in 902. It should be appreciated that the number of statements required, the type of statements received, and the optimized accuracy values may be adapted to reflect different priorities, different fields, etc. For example, in the job context, some positions may require a lower level of qualifications from applicants. In this scenario, it may be more useful and efficient to require less statements to train an appropriate neural, with optionally less accuracy, as the investment in the employee may be less. Conversely, in positions with a large number of applicants, a higher level of accuracy, and hence more statements analyzed, it may provide additional benefits by more selectively choosing the most qualified candidates, and so on. The system will also provide an information panel for the end-user for work load management in 903.

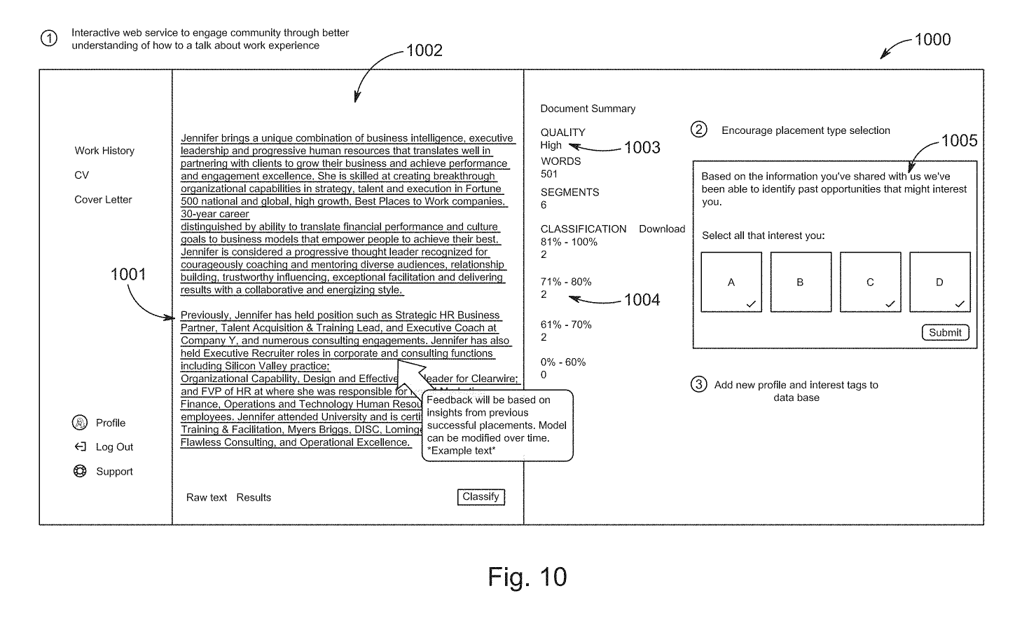

FIG. 10 illustrates an example process or workflow 1000 for using neurals or intelligent agent models to help applicants improve job applications for job postings. The end-user will interact with the system though a dialog box provided by dialog box 1001. Process 1000 may be performed, at least in part, by the system 200 described above in reference to FIG. 2, and the qualitative results will be communicated back to the end user through color highlighting 1002 illustrated in dialog box 1001.

Process 1000 may be implemented to increase new candidate engagement opportunities through scalable technology services (e.g., utilizing system 200 to provide a service that in some cases, is constantly or periodically updated with new information, models, etc.). The system will be able to provide an overall qualitative assessment of a document through dialog box 1003. Process 1000 may improve the quality of new and old engagements by offering expertise and advice on “how to best describe work experience” and other job specific descriptions and requirements based on an organization's previous successes. A leadership team's expertise may be encoded into a proprietary machine model, to provide a competitive advantage and improve brand recognition. Process 1000 may establish data streams to be used for improved services or new revenue opportunities. The underlying system will also provide quantitative metadata pretraining to document through dialog box 1004.

In some aspects, a talent analyst may utilize system 200 to setup and configure placement types based on historical positive results. In some cases, between 10 and 50 different placement types may be configured, for example, to balance processing time with accuracy. However, it should be appreciated that any number of different placement types may be configured. Training data may be collected, organized, and used to establish an appropriate neural network model or models. A set of training rules or guidelines may then be established and implemented. The models may be provided and accessed via a web application. In some aspects, users of the web application may provide feedback, which can be used to update the models and/or system rules or guidelines to adaptively provide more accurate and useful results, for any of a number of different fields and applications. These interactions will be handled through a selection environment depicted in 1005.

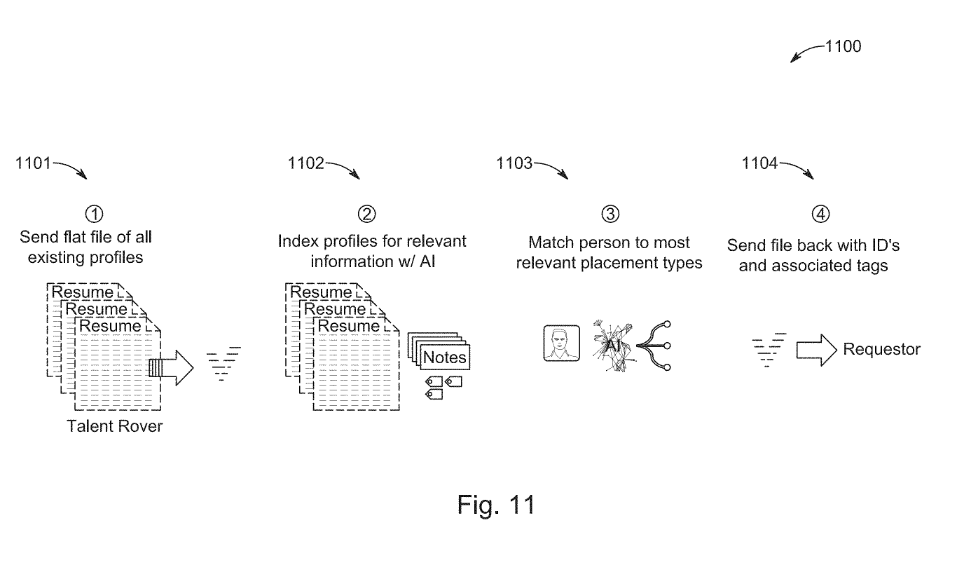

FIG. 11 illustrates an example process or workflow 1100 for talent organization, which may be performed, at least in part, by system 200 described above in reference to FIG. 2.

Process 1100 may provide ways to better understand the quality of candidate profiles and how they align to recent placement types. Process 1100 may enable searching for candidates based on placement types that were previously tagged or linked to profiles. Faster and more informed decisions may be provided by process 1100 on who to invest time in by understanding related placement types against content in profiles.

In some cases, a talent analyst may setup and configure placement types based on historical positive results. In some cases, between 10 and 50 different placement types may be configured, for example, to balance processing time with accuracy. However, it should be appreciated that any number of different placement types may be configured. A number of profiles may then be analyzed. In some cases, this number may be approximately 50,000 or more different profiles. Each document, for example corresponding to a profile, may be analyzed using AI to evaluate the quality of each document or data source. The documents/data sources may be scrubbed or cleaned to remove noisy data, for example using AI, or known techniques. The entry point of candidate information extraction and noise removal for this pipeline is depicted in 1101. Certain documents may then be combined into Talent Vaults. A Talent Vault is a logical entity representation of data, as opposed to a document-based representation. The notion of an employee, for example, is defined within the system by a collection of resumes, projects, metadata, correspondence, etc. All of these documents contain various data points and each point may be more or less important to the profile of that employee. The described system may build a dynamic profile of an entity from available data related to or describing that entity, and then apply one or more intelligent agent models to the dynamic profile to determine what pieces of data are significant to the analysis at hand. A “Vault” is a collection of these entity representations; in this case, a “Talent Vault” describes talent related entities. Unstructured talent data, as all big data, is essentially useless until structured and organized in some way. In some aspects, the data may be organized into or represented by layers. The bottom layer may contain document or source data, for example that is uncorrelated. The second layer may include a logical entity layer where each entity is defined by a set of documents and relationships therein. This second layer would correspond to the Talent Vault.

The analyzed profiles may then be indexed, for example according to any number of indexing techniques. For example, the data may be indexed by entity, not by document. The documents may be said to be indexed by the entity. This can include indexing in the database sense of preprocessed and inserted into a database. The overall organization of this intelligent system will constitute the intelligent indexing profiles depicted of 1102. In some of aspects, a profile may be indexed from a talent vault, using a concept oracle. The profile would be indexed, using this oracle, into a NoSQL database, for example, such as Xapian, as described in U.S. application Ser. No. 14/952,495 filed Nov. 15, 2015, titled “Systems and Methods to Determine and Utilize Conceptual Relatedness Between Natural Language Sources,” the contents of which are hereby incorporated by reference as if fully set forth herein.

Next, profiles may be matched to placement types. This process will involve evaluating the candidate's similarity to the most appropriate position through the matching mechanism as depicted by 1103. The profile IDs and associated tags may then be formatted and communicated to the requesting organization to better inform how to judge or rank candidates for a given position as illustrated in 1104.

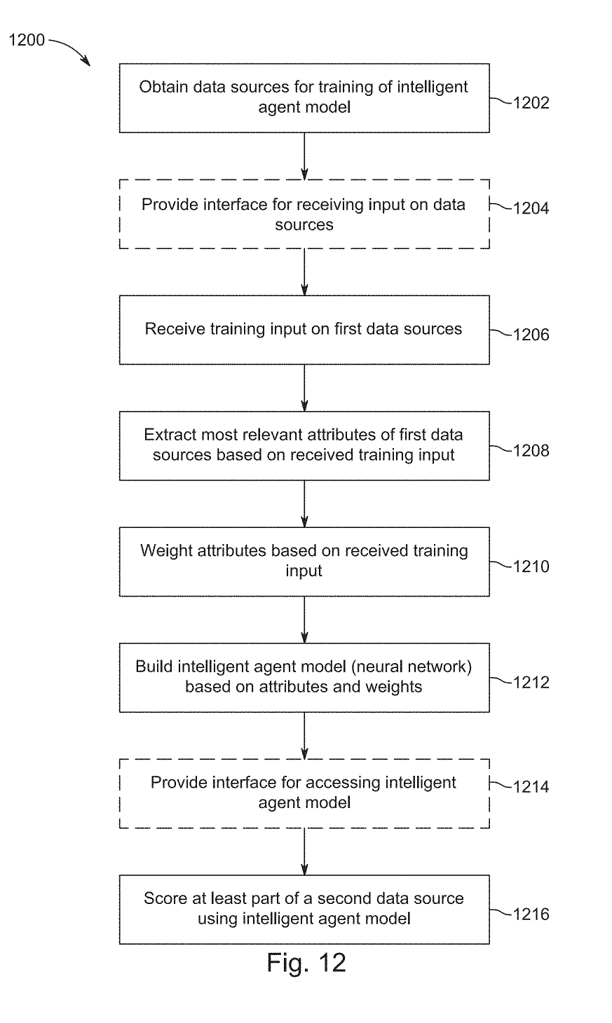

FIG. 12 illustrates an example process 1200 for training and using an intelligent model to score a data source, which may be performed by the system of FIG. 2. As illustrated, operations or boxes indicated via dashed lines are optional, such that in some aspects, process 1200 may be performed without those operations. The proposed process begins by accepting data from end-users 1202 followed by possible post-processing through user interfaces provided by system 1204. The entry points will be able to receive training data for construction of intelligent models 1208. The system will use internal processes to identify the most relevant information components from provided data 1210. The system will utilize the provided training data to construct a discriminative, supervised neural network model based on training data 1212. The system can provide an optional interface for interacting with the trained model for assessment, evaluation, and accuracy characterization 1214. The intelligent system can be available for interaction for tasks such as classification and ranking of the candidates through available processes 1216.

While the preferred embodiment of the disclosure has been illustrated and described, as noted above, many changes can be made without departing from the spirit and scope of the disclosure. Accordingly, the scope of the described system, method and techniques is not limited by the disclosure of the preferred embodiment. Instead, the described systems and methods should be determined entirely by reference to the claims that follow.

What is claimed is:

1. A system for developing an intelligent agent model of intelligent computational agents, comprising:
a curation tool for obtaining information from an expert, the curation tool generating training data;
a computational block coupled to receive the training data, the computational block employing an algorithm to generate encoded expertise; and,
an intelligent agent created at least in part by and coupled to receive the encoded expertise.

2. The system of claim 1 in which the intelligent agent model is a neural network.

3. The system of claim 1, further comprising:
a user interface coupled to the intelligent agent and supplying a sample to the intelligent agent.

4. The system of claim 3, wherein the intelligent agent generates and provides an expert opinion to the user interface based on the sample.

5. A method for creating an intelligent agent model for providing an expert opinion on source data, the method comprising the steps of:
obtaining at least one first data source for training an intelligent agent model;
receiving training input on the at least one first data source from an individual;
extracting a set of relevant attributes of the at least one first data source based on the received training input;
weighting the set of relevant attributes based on at least one of the group of the received training input and prior received training input;
forming at least one neural network that comprises the intelligent agent model based on the set of relevant attributes and the weighting;
ranking or scoring at least one section of a second data source using the intelligent agent model; and
outputting the ranking or scoring.

6. The method of claim 5, wherein ranking or scoring the at least one section of the second data source using the intelligent agent model comprises the steps of:
receiving at least one output from the at least one neural network, wherein the output is derived from interactions between a plurality of nodes in the at least one neural network; and,
wherein outputting the ranking or scoring further comprises outputting a representation of a map of the outputs of the plurality of nodes as a basis for the scoring or ranking.
